(19) United States
(12) Patent Application Publication
(10) Pub. No.: US 2004/0149720 A1
(43) Pub. Date: Aug. 5, 2004

(54) Method of warning individuals about hot surfaces on portable grills and other appliances

(76) Inventor: William S. Lerner, New York, NY (US)

Correspondence Address: Steven Horowitz, Counselor At Law, Suite 700, 295 Madison Avenue, New York, NY, 10017, US

(21) Appl. No.: 10/687,530

(22) Filed: Oct. 16, 2003

Related U.S. Application Data
(63) Continuation-in-part of application No. 09/788,594, filed on Feb. 21, 2001, now Pat. No. 6,639,190.

(51) Int. Cl. H05B 3/68

(52) U.S. Cl. 219/445.1; 219/506

(57) ABSTRACT

A method of warning individuals about the top or side surface of an indoor counter top grill, panini maker or quesadilla maker involves applying to a portion a thermochromic composition that reveals a heat warning symbol to warn individuals that surface is too hot to touch. Liquid crystal or other thermochromic composition designed to undergo and maintain a readily perceptible color change at or above a specified temperature, the color change revealing a heat warning symbol. Thermochromic ink or epoxy is applied sprayed, stamped, stenciled, silk screened, embossed to the hot surfaces of appliances. The heat warning symbol is invisible when cold and is visible when a threshold temperature is reached. The method can also employ a plurality of heat warning symbols on multiple surfaces of the appliance to maximize the warning system's effectiveness and tailor it to children and adults.

### PRIORITY INFORMATION

This patent application is a continuation-in-part patent application of (a) the presently pending U.S. patent application Ser. No. 09/788,594 (“Heat Alert Safety Device for Smoothtop Stoves and other Hot Surfaces”) previously filed by Applicant and Inventor William S. Lerner on Feb. 21, 2001 and which is incorporated herein by reference in its entirety (b) the presently pending U.S. patent application Ser. No. 10/429,111 (“Heat Warning Devices Directly Applicable to Hot Surfaces”) previously filed by Applicant and Inventor William S. Lerner on May 2, 2003 and which is incorporated herein by reference in its entirety (c) the presently pending U.S. patent application Ser. No. 10/447,510 (“Heat Warning Devices Directly Applicable to Hot Surfaces”) previously filed by Applicant and Inventor William S. Lerner on May 28, 2003 and which is incorporated herein by reference in its entirety (d) the presently pending U.S. patent application Ser. No. 10/612,315 (“Heating Element Accessory Having Warning Device”) previously filed by Applicant and Inventor William S. Lerner on Jul. 2, 2003 and which is incorporated herein by reference in its entirety and (e) the presently pending U.S. patent application Ser. No. 10/658,214 (“Method of Warning Individuals about Hot Surfaces on Stoves Including Cooktops”) previously filed by Applicant and Inventor William S. Lerner on Sep. 8, 2003 and which is incorporated herein by reference in its entirety.

### FIELD OF THE INVENTION

The present invention relates to methods of using heat warning symbols to warn individuals about the hot surfaces that exist on appliances, and in particular methods of using heat warning symbols to alert someone that the surface of an indoor counter top grill or similar appliance is too hot to touch.

### BACKGROUND OF THE INVENTION

Grills are a kind of electric cooking device. Recently, portable indoor grills that can be positioned on counter tops in the kitchen have become prevalent. Whereas grills were previously associated with a lot of smoke, indoor counter top grills drain enough fat to avoid burning oil and grease and smoking up the kitchen. Since grilling is a healthier way to cook meats and other foods, these indoor counter top grills have become very popular over the last seven or so years. Indoor grills have been made more convenient than the clumsy outdoor grill of decades ago. Sleek stand alone indoor counter grills, such as the George Foreman® grill sold by Salton, Inc. of Lake Forest, Ill. or the Hamilton Beach line of grills sold by Hamilton Beach/Proctor-Silex, Inc. of Southern Pines, N.C., have become popular ways of grilling meat, poultry, seafood, vegetables, fruit and breads. Other similar appliances which grill food include panini makers, which grill paninis (cheese and/or sandwiches) and quesadilla makers, which grill quesadilla (filled wheat tortilla topped with meat and/or cheese). These are roughly the same size and the indoor counter top grills and together with the indoor counter top grills are sometimes referred to herein as “grill and related appliances”.

There is a compelling need for individuals who use these grills and related appliances to be warned about the top and side of the grill remaining hot after being shut off (or even while still on). Nonetheless, these grills are popular because they are convenient and reasonably priced ways of grilling the above kinds of foods indoors. Since these grills are popular precisely because of their low cost and that they are compact and sleek, attaching to these indoor counter grills an accessory that is bulky or that occupies a significant amount of visual or physical space or using a warning method of device that is expensive due to being complicated to carry out or to manufacture would be impractical from the point of view of the marketing of these grills since it would undermine the very things that contribute to their appeal. Accordingly, to date, there is no known warning device or method used on these grills and related appliances to warn individuals that their surfaces may be too hot to touch.

The earlier patent applications by Applicant William S. Lerner which Applicant claims priority from, for example U.S. patent Ser. No. 10/658,214 (“Method of Warning Individuals about Hot Surfaces on Stoves Including Cooktops”) have discussed the problems concerning warning individuals about hot surfaces on stoves. This patent application is directed to method of warning individuals about the potentially hot surfaces that exist on on portable indoor counter grills and similar appliances.

Any method or apparatus which employs a device including a thermochromic composition by its nature also uses up physical space since the thermochromic composition has a container and the container has to be attached to the surface of the appliance by either a magnet, an adhesive layer or some other attachment element. Consequently, the heat warning safety device typically juts out of the surface. That may make the surface bulkier.

Furthermore, the heat warning safety device that appears on the surface of an appliance necessarily uses up a certain amount of visual space. In other words, the surface of an appliance has a logo on it and possible other information such as instructions. It is important for appliance manufacturers to allow their logo to stand out. It is well established principle of writing advertising copy that having too busy a visual environment makes it difficult to catch the attention of the viewer to the desired message; whereas empty visual space near the message draws the viewer's eye to the message. It is therefore desirable for any method or apparatus employing a heat warning device to minimize the amount of visual space it uses on the surface of the appliance.

In addition, while minimizing the visual space used by a heat warning safety device may be desirable on the hot surface of an appliance, the countervailing consideration is that children cannot be expected to know where to look for heat warning without a conspicuous symbol conveying the heat warning. On the other hand, since adults could reasonably be expected to be taught to look at a surface to see whether a heat warning appears on the surface with a minimized visual prompt, and since children may not be similarly trainable, there is also a need for a method or apparatus employing a heat warning that is custom tailored for both children and adults.

Furthermore, while known heat warning safety devices can be made to fit a curved or a straight surface, one of such devices would not be expected to physically fit against both a curved and a straight surface.

There is also a need for a heat warning method or device that can communicate different degrees to which the surface of the appliance or other object is dangerously hot, i.e., hot versus very hot.

There is thus a need for a heat warning method or device that addresses the above concerns and does not require a container to house any apparatus that it uses and which can be applied directly to a surface in a simple manner. Furthermore, there is a need for such a method or device that minimizes the amount of visual space that it uses on the surface.

In addition, certain appliances, for example an indoor counter top grill and related appliances, may have multiple surfaces that are not all the same degree of dangerously hot and which would ideally require separate heat warning devices on each surface. Given that and the fact that as previously mentioned each such device uses up physical and visual bulk, it is all the more necessary to have a method or device(s) that do not use up so much physical and visual space.

There is a need for a method or apparatus that employs an assembly of heat warning devices that can be placed on multiple surfaces of an appliance or object having hot surfaces. There is also a need for such a method or apparatus employing an assembly each of whose devices has the mentioned advantages of the individual devices.

There is also a need for a heat warning method or device that maximizes the visual impact of the warning it communicates. In other words, there is a need to maximize the visual disparity between the appearance of the device when the surface is not dangerously hot and the appearance of the warning symbol or device when the surface is dangerously hot and a warning is being communicated.

In light of the above discussion there is a need for a method or apparatus and an assembly of such devices that achieves all of the above objectives and which is also suitable for temperatures at least up to a high temperature of a grill (250 to 500° F.) since grills and related appliances get that hot. There is also a need for a method or apparatus and an assembly of such devices that is suitable for temperatures at least 300 degrees Fahrenheit since thermochromic compositions that are commonly available are reliably stable at cycling back and forth at that temperature and certain surfaces that require a warning device will not get hotter than that temperature.

It is believed that no heretofore known method or apparatus simultaneously meets these requirements. The present invention does.

### SUMMARY OF THE INVENTION

The present invention is a method of warning individuals about hot surfaces of indoor counter top grill and similar appliances. The method uses involves applying thermochromic composition directly to the top or other surface of the grill. The thermochromic composition changes color and remain at that color when the surface of the heating element or surrounding area exceeds a certain temperature. The thermochromic composition is typically liquid crystal compositions, liquid crystal polymers designed to turn color when they reach a certain temperature. When the surface is “cold” the present invention is not seen

The method of the present invention uses thermochromic ink or epoxy material in the form of a heat warning symbol that is directly applied to a hot surface such as by being sprayed, stamped, stenciled, silk screened, embossed, printed or written on to the hot surface of the appliance. For example, the letters “HOT” are a common type of heat warning symbol. The heat warning symbol and thermochromic composition used in the method of the present invention is invisible when “cold” (i.e. when not hot enough to be considered too hot to touch or dangerously hot) and is visible when a threshold temperature is reached. In a second version when not dangerously hot only the outline of the heat warning symbol is seen and when hot the full symbol is seen.

A plurality of these versions of the thermochromic composition can be placed on various parts or surfaces of an appliances or other hot surfaces to maximize the effectiveness of the warning system and to tailor the heat alert warning system to both children, who need guidance as to where to look for said warning symbols, and to adults, as to whom the impact is greatest when the warning symbol appears after being invisible.

The thermochromic composition used in the method of the present invention is entirely constructed out of material able to withstand repeated cycling to particular temperatures in the range of approximately 250 to 500 degrees Fahrenheit or more, and able to withstand rough treatment.

### OBJECTS AND ADVANTAGES

The following important objects and advantages of the present invention are:

(a) to provide a method of warning individuals about the hot surfaces of indoor counter top grills and related appliances that employs heat warning symbols;

(b) to provide a method of warning individuals about the hot surfaces of indoor counter top grills and related appliances that employs heat warning symbols that are immediately recognizable as warning that the surface(s) is dangerously hot;

(c) to provide a method that instantly warns anyone including a child that the surface of an indoor counter top grill or related appliance is too hot to touch,

(d) to provide a method of warning individuals about the hot surfaces on an indoor counter top grill or related appliance that instantly displays to anyone the letters “HOT” as a warning on the surface of the grill,

(e) to provide such a method for indoor counter top grills that can be applied to any surface of the grill;

(f) to provide such a method that employs a heat warning symbol that cannot be tampered with by children or even by adults;

(g) to provide such a method that does not use up a significant amount of physical space on the appliance or on the appliance's surfaces that may become hot;

(h) to provide such a method that does not use up a significant amount of visual space on the appliance or on the appliance's surfaces that may become hot;

(i) to provide such a method that can be custom tailored for both children and adults;

(j) to provide such a method that is equally applicable to both a flat surface and a curved surface;

(k) to provide such a method that can communicate differing degrees of dangerously hot, i.e. differing levels of heat;

(l) to provide such a method that is easy to perform;

(m) to provide such a method that employs heat warning symbols using compositions that can withstand high temperatures, i.e. 300 degrees Fahrenheit;

(n) to provide such a method that can employ an assembly of heat warning symbols covering multiple surfaces of a particular appliance or object;

(o) to provide such a method that can maximize the visual impact of the heat warning symbol by maximizing the disparity between the warning symbol when cold and the warning symbol when dangerously hot;

(p) to provide a method of warning individuals about hot surfaces on the top or side of indoor counter top grills and like appliances which employs a heat warning symbol that is essentially invisible during the periods of time in which a heat warning is not needed, i.e. when the surface is “cold”;

(q) to provide such a method that is easy to perform and that can be include the step of manufacturing the grill or that can involve installing on to a grill a warning symbol in accordance with the methods of the present invention,

(r) to provide such a method that applies to the grill a heat warning symbol that can be calibrated to signal the word “HOT” only when a certain temperature, such as 115 degrees Fahrenheit, is reached and that can remain in signaling mode as long as such temperature is exceeded by the appliance surface,

(s) to provide a method that uses a heat warning symbol that makes use of liquid crystals that change color when a certain temperature is reached, such as cholesteric liquid crystals, chiral nematic or various types of liquid crystal polymers designed to change color when a certain temperature is reached; and

(t) to provide such a method that is not only applicable to the potentially hot surfaces of indoor counter top grills but also the potentially hot surfaces of like appliances such as panini makers and quesadilla makers.

### BRIEF DESCRIPTION OF THE DRAWINGS

FIG. 1 is a perspective view of an indoor counter top grill having a heat warning symbol both on the top surface and on the side surface

### DETAILED DESCRIPTION OF THE DRAWINGS

The present invention is a method of warning individuals that a top or other surface of an indoor counter top grill, panini maker or quesadilla maker is hot. In one preferred embodiment with respect to a grill the method comprises the steps of (a) manufacturing a grill having a top surface on its lid or cover, and then (b) applying to a surface of the grill a thermochromic composition in liquid or semi-liquid state, the thermochromic composition designed to undergo and maintain a readily perceptible color change whenever and so long as the area exceeds a predetermined temperature, the color change of the thermochromic composition revealing a heat warning symbol that communicates that the area is dangerously hot, and (c) allowing the thermochromic composition to dry to a solid state.

Another feature of the present invention is applying the thermochromic composition means applying the thermochromic composition that is sufficiently similar in color to a background color of the surface that the thermochromic composition and the heat warning symbol are readily visible against the background color of the surface only when and so long as the temperature of the surface exceeds the predetermined temperature. The thermochromic composition that is applied is designed to undergo and maintain a readily perceptible color change whenever and so long as the surface of the grill or other appliance exceeds a predetermined temperature, the color change of the thermochromic composition revealing a heat warning symbol that communicates that the top surface of the grill is dangerously hot, and then (c) allowing the thermochromic composition to dry to a solid state. If one begins with an already existing grill, then step (a) is unnecessary and the method begins with step (b) described above.

The phrase “liquid or semi-liquid” is intended to include, but is not necessarily limited to, anything that can be sprayed, printed, embossed, written, stenciled, silkscreened or stamped onto a surface.

The ideal heat warning symbol is in a color known to represent warning, such red or orange, although the heat warning symbol can be in any color in accordance with the present invention.

It should be understood clearly that the thermochromic composition of the present invention reveals a predetermined symbol whenever and so long as the temperature of the surface that the composition is on exceeds a predetermined temperature. This can be arranged in a variety of ways. For example, this can happen as a result of the thermochromic composition turning color and being shaped in the shape of the heat warning symbol (or the background of such symbol). It can also happen as a result of the thermochromic composition covering the heat warning symbol and then becoming invisible at the triggering temperature to reveal a separate heat warning symbol that is underneath the thermochromic composition. It could also happen (and this is believed that the cheapest and most cost-effective way of effectuating the revealing of the heat warning symbol) as a result of the heat warning symbol being written, imprinted or otherwise applied on top of the thermochromic composition (for example using an ink or similar applicator) but in a way that it is not readily visible (i.e. the disparity in color between the two is not sufficient to make the heat warning symbol readily visible) and then when the thermochromic composition turns invisible the heat warning symbol is visible against a white background.

In any case, the thermochromic composition, when the triggering temperature is reached, simply turns into a color that makes the symbol readily visible. For example, the thermochromic composition can turn red at the triggering temperature and be shaped in the form of the symbol or shaped in the background of the symbol. The second way is that the thermochromic composition, until the triggering temperature occurs, blocks the visibility of a red heat warning symbol underneath it. When the triggering temperature arrives, the thermochromic composition becomes invisible and reveals the underlying red symbol.

In either case, it is preferable that the entire heat warning symbol and the thermochromic composition be substantially invisible against a background color of the surface of the grill prior to the triggering temperature being exceeded due to the thermochromic composition being sufficiently similar in color to the color of the surface. This is so that the presence of the heat warning symbol and thermochromic composition be invisible or not readily visible prior to the triggering temperature being exceeded. This has two advantages: (i) the warning is more dramatic when it arrives and (ii) the presence of the warning does not clutter or mar the appearance of the surface of the grill or other appliance

In the case where the thermochromic composition covers a previously written or formed heat warning symbol, preferably, the heat warning symbol was formed or written in some cases underneath the thermochromic composition by whatever well known processes employ the least expensive means, such as printing, writing, stamping, scratching, etc. Accordingly, although the drawing figures of the present invention may seem to be directed to the case in which the thermochromic composition is itself in the shape of the letters “H,O,T” or other heat warning symbol, it should be understood that the drawings could just as well be depicting the case in which the thermochromic composition has turned invisible (since the temperature has exceeded the predetermined temperature) and has revealed beneath said composition the heat warning symbol such as the letters “HOT” printed or otherwise fixed onto some tangible medium of expression such as paper or any other object.

It is to be understood that a heat warning symbol (sometimes called a “heat symbol”) can take multiple forms and is not limited to the letters “HOT”. The present invention contemplates that other letters and other letter shapes (in any language) besides that of “HOT” could be used as a warning symbol although it is believed that the simple arrangement of the letters “HOT” in a bold simple typeset provide the best warning symbol. The symbol may also take the form of a exclamation point, an international “no” symbol superimposed on a stick diagram of a figure touching a surface, a stylized human face showing shock or pain, a representation of flames, or any other recognizable warning symbol. Furthermore, the present invention also contemplates that the thermochromic composition in the outline of the letters “HOT” can be embedded in a surface of an indoor counter top grill or other appliance where the surface is vertical and perpendicular to the floor, not only horizontal. The depth and configuration of the thermochromic composition can vary and still be within the scope of this invention.

In some embodiments, when the temperature of the surface does not exceed the predetermined temperature the thermochromic composition is not readily visible against a background color of the hot surface. This further dramatizes the appearance of the warning symbol when the temperature does exceed the predetermined temperature.

The surface of the grill can otherwise be flat or it can be curved and the method of the present invention would work equally well since there is no housing or container needed to house the heat warning symbol. The heat warning symbol occupies virtually no bulk and since the thermochromic composition is applied to the surface by being sprayed, printed, stamped, written, etc. in liquid or semi-liquid form, the surface can be curved or flat. Furthermore the surface of the grill can be smooth or can have a very shallow recess into which the thermochromic composition is placed.

When the thermochromic composition is applied by being sprayed, stenciled, embossed, stamped, silk screened, printed or otherwise applied to the surface 30, the composition 20 is typically applied initially in a liquid or semi-liquid form. Only then it dries or dries instantly. The term “semi-liquid” is a broad term intended to encompass a malleable solid form. Accordingly, thermochromic composition 20 is capable of being applied as a liquid or semi-liquid directly to the surface 30 in the predetermined shape and it is capable of remaining on surface 30 in its predetermined shape in solid form after being left to dry. It is capable of withstanding temperatures in excess of 500 degrees Fahrenheit in certain embodiments. The present invention, however, does contemplate applying the thermochromic composition in some manner that said composition is immediately or almost immediately in essentially solid form.

As previously explained, in a preferred embodiment, the thermochromic composition turns invisible at the triggering temperature and reveals the heat warning symbol underneath the composition. In the present invention it is advantageous to not have to modify the manufacturing of the indoor counter top grill significantly and it is preferable to maintain the essentially smooth surface of the grill even after the thermochromic composition (or such composition and the heat warning symbol) has been installed/applied onto the surface of the grill.

Accordingly, in cases when the thermochromic composition turns invisible at the triggering temperature (as opposed to turning to a visible color and the composition itself being in the shape of the heat warning symbol) the underlying heat warning symbol can be present in the following way without marring the essentially smooth top surface of the grill and without altering the ordinary manufacturing of the grill or like appliance. One way is to simply have the letters “H,O,T” or other heat symbol sprayed on over a stencil, onto the smooth cook top surface using liquid that is not thermochromic—just ordinary paint or spray that is capable of withstanding high temperatures, such as sprayable epoxy resin, epoxy paint or ink. It need not be thermochromic. Then on top of that layer, one can simply apply by any well known process directly on to the surface a layer of thermochromic composition in the form of ink or epoxy resin in a form that entirely covers the heat warning symbol. The non-thermochromic ink that would be appropriate would be any durable, non-fading, heat resistant ink.

Alternatively, the thermochromic composition can be located on a thin surface or object. The surface can be a layer of aluminum foil or other thin metal, colored enamel, colored aluminum, or any other object or surface that can be written on and that can withstand the heat of several hundred degrees Fahrenheit. Ideally, the heat warning symbol has a reflective quality to increase visibility. There are well known means to make lettering have a reflective surface—it could be the reflective quality of the foil, it could be a holographic effect or any other means well known in the art.

The thermochromic composition on the indoor counter top grill or panini or quesadilla maker is very thin. It has the thickness of written ink embossed, sprayed or otherwise applied to a smooth surface. For example, a smooth surface of an appliance may have embossed thereon a particular logo or product name. If an individual were to close his eyes and feel that surface they would be able to feel the raised ink but only barely. Accordingly, the thickness in solid form of thermochromic composition 20 is such that the thermochromic composition is either faintly visible or invisible when viewed from a line of light tangent to the surface 30 by someone whose attention is not specifically directed to said thermochromic composition. Although a side view of the thermochromic composition would show a visible surface, that is simply to illustrate the fact that there is at least some thickness and would not be to scale.

Typically, composition 20 is applied as a liquid directly to the surface by being sprayed, stamped, stenciled, printed, embossed or silk screened onto said surface. Thermochromic compositions that are suitable are well known and include inks and epoxy resins. For example, the following are examples of thermochromic compositions made by various companies that are applicable to the present invention. Hallcrest, Inc. makes color change products that are temperature sensitive. For example, Hallcrest, Inc. manufactures microencapsulated thermochromic liquid crystal slurries and sprayable microencapsulated thermochromic liquid crystal coatings. Chromatic Technologies, Inc. of Colorado Springs, Colo. manufacturers Dynacolor® Resin for epoxy screen ink or Dynacolor® thermochromic reversible ink. Matsui International Company, Inc. manufacturers a product called Chromicolor® which is an epoxy resin spray paint.

By applying the thermochromic composition on the top surface of the grill, instead of embedding it underneath the surface in a bulky surrounding, the method of the present invention can be easily integrated into the existing manufacturing process used to make indoor counter top grills. The surface of the grill is manufactured the way they would be made without the method of the present invention. Afterwards, the thermochromic composition can be directly applied on to the top or side surface(s) of the indoor counter top grill, as explained, by spraying, etc. This is an inexpensive intrusion into the manufacturing of the grill yet it provides the advantages of having a heat warning.

Furthermore, since the heat warning symbol is preferably not embedded below or well below a top or side surface of the appliance surface, it can be seen more visible from a wider range of angles.

It should be noted in general that the present invention makes use of any liquid crystal composition that changes color and remains at that color when a specified temperature is reached or exceeded—it need not necessarily be cholesteric, although it has been found that cholesteric liquid crystals do this effectively. It is also within the scope of the present invention to make use of a liquid crystal composition that changed color when it reached a specified temperature or temperature range but changed to a third color at a higher threshold temperature, so long as the third color is significantly different from the first color—although this would certainly not be the ideal kind of liquid crystal composition. The ideal composition turns red at a specified temperature and remains red above that temperature.

With use of the present invention, when an individual enters the kitchen with the indoor counter top grill in it he or she can instantly recognize if any of its surfaces are too hot even when the grill has been turned off.

The present invention contemplates that other letters and other letter shapes besides that of “HOT” could be used as a warning although it is believed that the simple arrangement of the letters “HOT” in the simplest typeset provide the best warning.

It is also contemplated by the present invention with respect to all embodiments that in addition to the liquid crystal composition conveying the outline of the letters “HOT” by being in an outline of the letters “HOT”, the liquid crystal composition could instead convey the outline of the letters “HOT” by being in the background of such an outline. By this is meant that the liquid crystal composition would form the entire area except an outline of the letters “HOT”. The point of one feature of the present invention is to use the liquid crystal composition to create a color contrast between red and some other color in order to depict the letters “HOT” in red whether by virtue of the liquid crystal composition itself being the letters “HOT” or whether the liquid crystal composition surrounds the letters and in effect constitutes everything else except the letters “HOT” or whether the thermochromic composition covers a previously inscribed symbol and becomes invisible to reveal such symbol at the triggering temperature. Furthermore, it should be noted that in this patent application, the term “red” refers to all possible variations and shades of the color red as well as to all possible variations of the color orange. Red and orange are the colors associated with heat. Furthermore, if the hot surface (as opposed to the area of the liquid crystal composition) itself is or becomes red when hot, then the liquid crystal composition 230 would have to be orange and vice versa.

It was previously noted that the thermochromic composition used in the method of the present invention is entirely constructed out of material able to withstand repeated cycling to particular temperatures in the range of approximately 250 to 500 degrees Fahrenheit or more, and able to withstand rough treatment. As technology progresses, it is believed that thermochromic compositions that can withstand repeated cycling to even higher temperatures and still be durable will become available. The use of such compositions in the method of the present invention is contemplated.

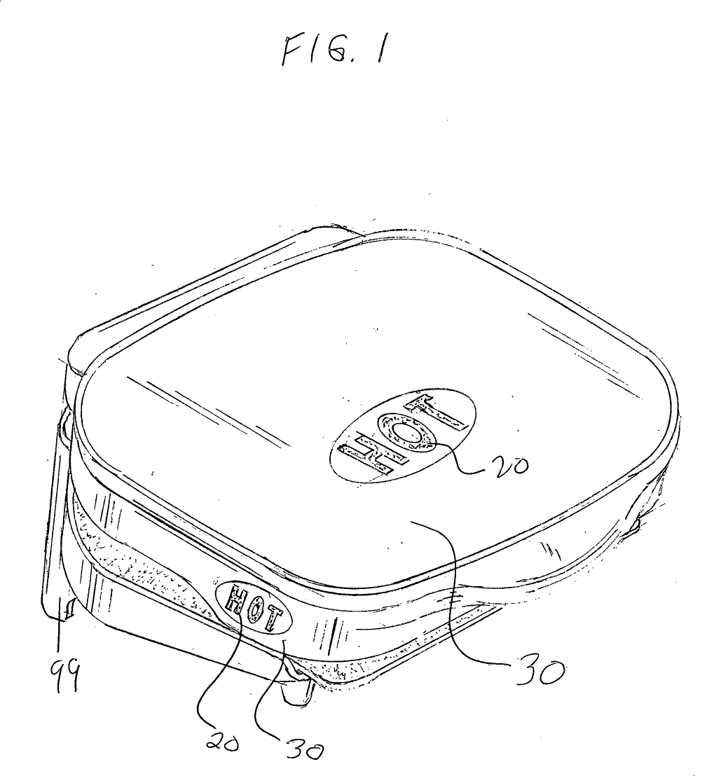

The oval line in FIG. 1 surrounding thermochromic composition 20 on surface 30 either represents a naturally occurring line on the surface 30 of the grill 99 or can indicate a bump or a recess. This oval line is not an essential feature of the present invention.

In general, it is to be understood that while the method of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact steps of the method shown or described nor to the exact construction and operation of the apparatus shown and described and used in such steps of the method. The spirit and scope of this invention are limited only by the spirit and scope of the following claims.

What is claimed is:

1. A method of warning individuals that a surface of an indoor counter top grill may be hot, the method comprising:
(a) applying to a surface of the grill a thermochromic composition in liquid or semi-liquid state, the thermochromic composition designed to undergo and maintain a readily perceptible color change whenever and so long as the area exceeds a predetermined temperature, the color change of the thermochromic composition revealing a heat warning symbol that communicates that the area is dangerously hot, the thermochromic composition being sufficiently similar in color to a background color of the surface that the thermochromic composition and the heat warning symbol are readily visible against the background color of the surface only when and so long as the temperature of the surface exceeds the predetermined temperature, and
(b) allowing the thermochromic composition to dry to a solid state.

2. The method of claim 1, wherein said method includes an additional step that occurs prior to step (a) of the method, said additional step comprising manufacturing an indoor counter top grill

3. The method of claim 1, wherein the applying of the thermochromic composition is performed by spraying, stamping, printing, writing, stenciling, embossing or silk screening the thermochromic composition onto the surface.

4. The method of claim 3, wherein said method includes an additional step that occurs prior to step (a) of the method, said additional step comprising manufacturing an indoor counter top grill

5. The method of claim 3, wherein applying a thermochromic composition designed to undergo a color change that reveals a heat warning symbol means applying a thermochromic composition designed to undergo a color change that reveals a heat warning symbol, said heat warning symbol being in the form of the letters “HOT”.

6. The method of claim 1, wherein the applying of the thermochromic composition involves applying thermochromic composition that is ink or epoxy resin.

7. The method of claim 3, wherein the applying of the thermochromic composition involves applying thermochromic composition that is ink or epoxy resin.

8. The method of claim 1, wherein applying a thermochromic composition designed to undergo a color change that reveals a heat warning symbol means applying a thermochromic composition designed to undergo a color change that reveals a heat warning symbol, said heat warning symbol being in the form of the letters “HOT”.

9. The method of claim 1, wherein applying to a surface of the grill a thermochromic composition in liquid or semi-liquid state means applying to the surface a thermochromic composition that is capable of withstanding temperature of between approximately 250 degrees and approximately 300 degrees Fahrenheit.

10. The method of claim 1, wherein the applying of the thermochromic composition is performed by spraying, stamping, printing, writing, stenciling, embossing or silk screening the thermochromic composition onto the surface and wherein applying to a surface of the grill a thermochromic composition means applying to the surface a thermochromic composition that is capable of withstanding temperature of between approximately 250 degrees and approximately 300 degrees Fahrenheit.

11. The method of claim 10, wherein the applying of the thermochromic composition involves applying thermochromic composition that is ink or epoxy resin.
